(19) United States
(12) Patent Application Publication
(10) Pub. No.: US 2016/0298485 A1
(43) Pub. Date: Oct. 13, 2016

(54) SPEED SENSOR FOR A GAS TURBINE ENGINE

(71) Applicant: United Technologies Corporation, Hartford, CT (US)

(72) Inventors: William G. Sheridan, Southington, CT (US); Jason Husband, South Glastonbury, CT (US)

(21) Appl. No.: 14/684,501

(22) Filed: Apr. 13, 2015

(51) Int. Cl. F01D 21/00; F02C 3/107; F01D 17/06

(52) U.S. Cl. CPC F01D 21/003; F01D 17/06; F02C 3/107

(57) ABSTRACT

A gas turbine engine includes a speed change mechanism. A fan drive shaft has a radially extending surface that is attached to the speed change mechanism. A speed sensor is located adjacent the radially extending surface.

### BACKGROUND

One type of gas turbine engine includes a fan drive gear system that is mechanically arranged between the turbo-machinery of the engine and a fan. The turbo-machinery is composed of two concentric shafts rotating at different speeds containing independent compressors and turbines. The turbo-machinery rotationally drives the fan, via the gear system, to move fluid through a nacelle which divides the fluid flow into two streams. An inner stream supplies the turbo-machinery and the outer stream consists of fluid which bypasses the inner stream and is solely compressed and moved by the fan.

Typically the fan drive gear system is provided by an epicyclic gear train and includes a centrally located input gear driven by the turbo-machinery, intermediate gears circumferentially arranged about and intermeshing with the input gear and a ring gear provided about and intermeshing the intermediate gears. Depending upon the configuration, either the intermediate gears or the ring gear rotationally drives the fan through a fan shaft in response to rotation of the input gear.

The intermediate gears are typically supported in a carrier by a journal extending between spaced apart walls of the carrier. The carrier is typically constructed from a high strength metallic alloy such as steel, titanium or nickel. The carrier is bolted to a torque frame, which is secured to fixed structure or rotating structure depending upon the particular type of gear system.

During operation of the gas turbine engine, a rotational speed of the fan shaft is monitored with a speed sensor to ensure proper functionality of the gas turbine engine. When the fan experiences a load, such as during a bird strike, the fan shaft may flex and change a distance between the speed sensor and the fan shaft, which could damage the speed sensor. Therefore, there is a need to reduce changes in the distance between the speed sensor and the fan shaft.

### SUMMARY

In one exemplary embodiment, a gas turbine engine includes a speed change mechanism. A fan drive shaft has a radially extending surface that is attached to the speed change mechanism. A speed sensor is located adjacent the radially extending surface.

In a further embodiment of the above, the radially extending surface faces in an axial direction.

In a further embodiment of any of the above, the radially extending surface is within 20 degrees of perpendicular to an axis of rotation of the gas turbine engine.

In a further embodiment of any of the above, the radially extending surface is located axially between a pair of fan drive bearings.

In a further embodiment of any of the above, the speed sensor is located axially upstream from the speed change mechanism.

In a further embodiment of any of the above, the speed sensor is located adjacent a fan drive bearing.

In a further embodiment of any of the above, the speed sensor is located axially between a pair of fan drive bearings.

In a further embodiment of any of the above, a mount flexibly supports at least a portion of the speed change mechanism.

In another exemplary embodiment, a gas turbine engine includes a speed change mechanism. A fan drive shaft has a radially extending surface that is attached to the speed change mechanism. A speed sensor is located adjacent a fan drive bearing.

In a further embodiment of any of the above, the speed sensor is located axially between a pair of fan drive bearings.

In a further embodiment of any of the above, the speed sensor is located adjacent a radially extending surface on the fan drive shaft. The radially extending surface faces in an axial direction.

In a further embodiment of any of the above, the radially extending surface is within 20 degrees of perpendicular to an axis of rotation of the gas turbine engine.

In a further embodiment of any of the above, the speed sensor is located axially upstream from the speed change mechanism.

In a further embodiment of any of the above, a mount flexibly supports at least a portion of the speed change mechanism.

In another exemplary embodiment, a method of designing a gas turbine engine includes locating a speed sensor adjacent a fan drive shaft. The speed sensor is positioned relative to a fan drive shaft such that movement of the fan drive shaft does not interfere with the operation of the speed sensor.

In a further embodiment of any of the above, the fan drive shaft is attached to a speed change mechanism.

In a further embodiment of any of the above, the speed sensor is located adjacent a radially extending portion of the fan drive shaft.

In a further embodiment of any of the above, the speed sensor is located adjacent a fan drive bearing.

In a further embodiment of any of the above, the speed sensor is located axially between a pair of fan drive bearings.

### BRIEF DESCRIPTION OF THE DRAWINGS

FIG. 1 is a schematic view of an example gas turbine engine.

FIG. 2 is a cross-sectional view of an example geared architecture.

### DETAILED DESCRIPTION

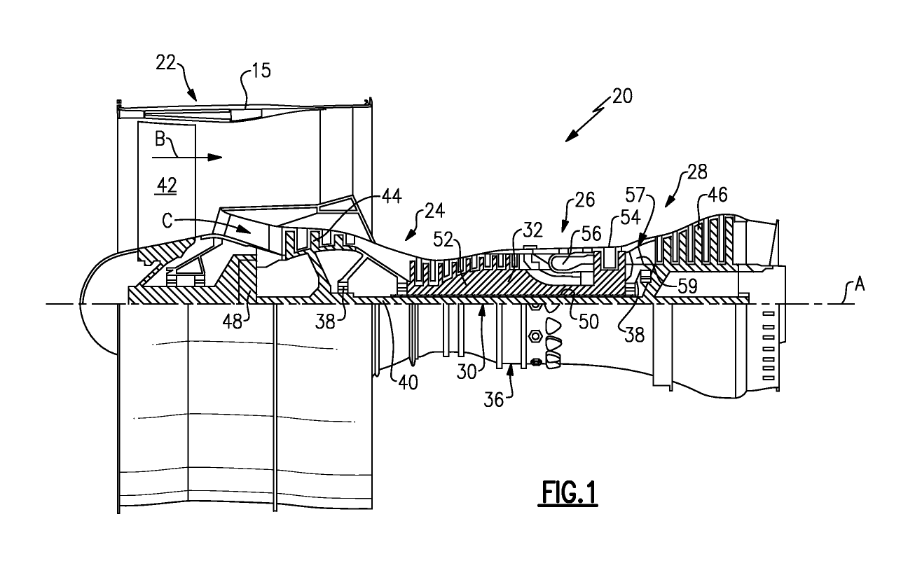

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7 °R)]^{0.5}. The “Low corrected fan tip speed” as disclosed herein according to one non-limiting embodiment is less than about 1150 ft/second (350.5 meters/second).

The example gas turbine engine includes fan 42 that comprises in one non-limiting embodiment less than about twenty-six (26) fan blades. In another non-limiting embodiment, fan section 22 includes less than about twenty (20) fan blades. Moreover, in one disclosed embodiment low pressure turbine 46 includes no more than about six (6) turbine rotors schematically indicated at 34. In another non-limiting example embodiment low pressure turbine 46 includes about three (3) turbine rotors. A ratio between number of fan blades 42 and the number of low pressure turbine rotors is between about 3.3 and about 8.6. The example low pressure turbine 46 provides the driving power to rotate fan section 22 and therefore the relationship between the number of turbine rotors 34 in low pressure turbine 46 and number of blades 42 in fan section 22 disclose an example gas turbine engine 20 with increased power transfer efficiency.

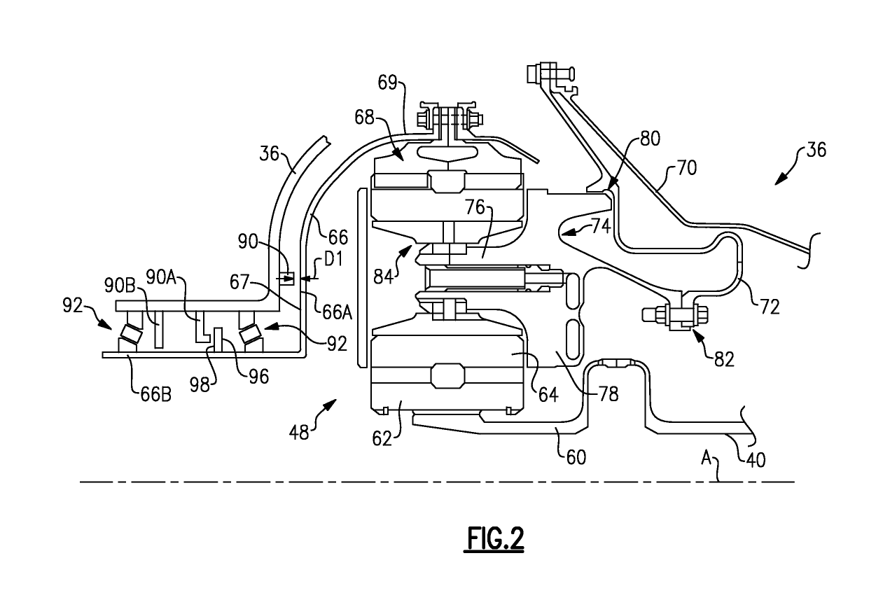

As shown in FIG. 2, the geared architecture 48 is attached to the inner shaft 40 through a flex shaft 60 to which an input gear 62 (sun gear) is mounted for rotation about an axis A. Intermediate gears 64 (in this example, star gears) are arranged circumferentially about and intermesh with the input gear 62. A ring gear 68 surrounds and intermeshes with the intermediate gears 64. Either the intermediate gears 64 or the ring gear 68 rotationally drives the fan drive shaft 66 depending upon the type of epicyclic gear train configuration.

In the illustrated example, the geared architecture 48 is a star gear system having the intermediate gears 64 rotationally fixed relative to a rotational axis of the input gear 62. That is, the intermediate gears 64 are permitted to rotate about their respective rotational axes but do not rotate about the rotational axis A of the input gear 62. The ring gear 68 is coupled to the fan drive shaft 66 which rotationally drives the fan 42.

The engine static structure 36 of the gas turbine engine 20 includes a bearing compartment case 70 and a support member 72. A torque frame 74 is affixed to the support member 72 which prevents rotation of the torque frame 74 about the rotational axis A of the input gear 62. Additionally, the support member 72 may be a flexible support to aid in maintaining alignment of the geared architecture 48 during operation of the gas turbine engine 20. In the case where the geared architecture 48 is a planetary gear configuration, the torque frame 74 would rotate about the rotational axis A and the ring gear 68 would be coupled to the engine static structure 36 with a rigid or flexible support.

The torque frame 74 includes multiple shafts 76 integral with a base 78 that provide first and second support features 80, 82 affixed to the support member 72. Each shaft 76 includes a bearing assembly 84 for rotationally supporting its respective intermediate gear 64. In one example, the torque frame 74 includes five equally circumferentially spaced shafts 76 that correspondingly support five star or intermediate gears 64. The base 78 and shafts 76 of the torque frame 74 are unitary and formed by a one-piece structure, for example, by a cast steel structure. Other high strength metallic alloys, such titanium or nickel, may also be used.

During operation of the gas turbine engine 20, a speed sensor 90 is used to monitor a rotational speed of the fan drive shaft 66. The speed sensor 90 is used to verify that the fan drive shaft 66 is rotating at an appropriate rotational speed relative to the inner shaft 40. A significant deviation from the predicted relative rotational speeds between the fan drive shaft 66 and the inner shaft 40 can indicate an uncoupling between the fan drive shaft 66 and the inner shaft 40 or a mechanical issue with the geared architecture 48. Therefore, having an accurate reading of the rotational speed of the fan drive shaft 66 is important when monitoring the health of the gas turbine engine 20.

In order for the speed sensor 90 to function properly and accurately measure the rotational speed of the fan drive shaft 66, a very small gap between the speed sensor 90 and the fan drive shaft 66 must be maintained. In the illustrated example, the gap extends a distance D1 between a distal end of the speed sensor 90 and a portion of the fan drive shaft 66. In one example, the speed sensor 90 is a magnetic pickup sensor and the distance D1 is approximately 0.030 inches (approximately 0.762 mm) However, additional types of speeds sensors 90 could be used in place of the magnetic pickup sensor.

During operation of the gas turbine engine 20, the geared architecture 48 is allowed to move on flexible supports to maintain alignment of the components in the geared architecture 48. The flexible supports include the flex shaft 60, a flexible ring gear support 69, the support member 72. In one example, the geared architecture 48 is allowed to move approximately 0.050 inches (1.27 mm) in a radial direction on the flexible supports.

When the gas turbine engine 20 experiences high loads, such as during bird strikes, the geared architecture 48 may flex as discussed above. During a bird strike, the geared architecture 48 can flex and move out of alignment with the speed sensor 90 or directly contact and possibly damage the speed sensor 90.

In one example, the speed sensor 90 is located adjacent a radially extending portion 66A of the fan drive shaft 66. The radially extending portion 66A includes a radially extending surface 67 that faces an axial direction. The radially extending surface 67 is within 20 degrees of perpendicular to the axis A of rotation of the gas turbine engine 20. By locating the speed sensor 90 adjacent the radially extending portion 66A of the fan drive shaft 66, the geared architecture 48 is able to flex under a load, and the radially extending portion 66A of the fan drive shaft 66 moves in a generally radial direction parallel to a distal end of the speed sensor 90 and avoids contact with the speed sensor 90.

The speed sensor 90 may also be located adjacent a fan drive bearing 92. The closer the speed sensor 90 is to the fan drive bearing 92 the less movement the fan drive shaft 66 will have relative to the speed sensor. Although the speed sensor 90 is located axially forward of the geared architecture 48 in the illustrated example, the speed sensor 90 could also be located downstream of the geared architecture 48 if the low pressure compressor 44 is tied to the fan 42.

In another example, a speed sensor 90A is located axially between a pair of the fan drive bearings 92. The speed sensor 90A is similar to the speed sensor 90 except where described below or shown in the Figures. The speed sensor 90A may be located closer to one of the two fan drive bearings 92 or directly between the two fan drive bearings 92. A distal end of the speed sensor 90A is located adjacent a radially extending flange 96 on an axially extending portion 66B of the fan drive shaft 66. The radially extending flange 96 includes a radially extending surface 98 that faces in an axial direction. The radially extending surface 98 is within is within 20 degrees of perpendicular to the axis A of rotation of the gas turbine engine 20.

In yet another example, a speed sensor 90B is also located axially between the pair of fan drive bearings 92. The speed sensor 90B is similar to the speed sensor 90 except where described below or shown in the Figures. The speed sensor 90B may be located closer to one of the two fan drive bearings 92 or directly between the two fan drive bearings 92. A distal end of the speed sensor 90B is located adjacent the axially extending portion 66B of the fan drive shaft 66.

Although the three speed sensors 90, 90A, and 90B are shown in the illustrated example, a single one of the speed sensors 90, 90A, and 90B could be utilized or any combination of speed sensors 90, 90A, and 90B could be utilized.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A gas turbine engine comprising:
a speed change mechanism;
a fan drive shaft having a radially extending surface attached to the speed change mechanism; and
a speed sensor located adjacent the radially extending surface.

2. The gas turbine engine of claim 1, wherein the radially extending surface faces in an axial direction.

3. The gas turbine engine of claim 2, wherein the radially extending surface is within 20 degrees of perpendicular to an axis of rotation of the gas turbine engine.

4. The gas turbine engine of claim 1, wherein the radially extending surface is located axially between a pair of fan drive bearings.

5. The gas turbine engine of claim 1, wherein the speed sensor is located axially upstream from the speed change mechanism.

6. The gas turbine engine of claim 1, wherein the speed sensor is located adjacent a fan drive bearing.

7. The gas turbine engine of claim 1, wherein the speed sensor is located axially between a pair of fan drive bearings.

8. The gas turbine engine of claim 1, further comprising a mount flexibly supporting at least a portion of the speed change mechanism.

9. A gas turbine engine comprising:
a speed change mechanism;
a fan drive shaft having a radially extending surface attached to the speed change mechanism; and
a speed sensor located adjacent a fan drive bearing.

10. The gas turbine engine of claim 9, wherein the speed sensor is located axially between a pair of fan drive bearings.

11. The gas turbine engine of claim 9, wherein the speed sensor is located adjacent a radially extending surface on the fan drive shaft and the radially extending surface faces in an axial direction.

12. The gas turbine engine of claim 11, wherein the radially extending surface is within 20 degrees of perpendicular to an axis of rotation of the gas turbine engine.

13. The gas turbine engine of claim 9, wherein the speed sensor is located axially upstream from the speed change mechanism.

14. The gas turbine engine of claim 9, further comprising a mount flexibly supporting at least a portion of the speed change mechanism.

15. A method of designing a gas turbine engine comprising:
locating a speed sensor adjacent a fan drive shaft;
positioning the speed sensor relative to a fan drive shaft such that movement of the fan drive shaft does not interfere with the operation of the speed sensor.

16. The method of claim 15, further comprising attaching the fan drive shaft to a speed change mechanism.

17. The method of claim 15, wherein the speed sensor is located adjacent a radially extending portion of the fan drive shaft.

18. The method of claim 15, wherein the speed sensor is located adjacent a fan drive bearing.

19. The method of claim 15, wherein the speed sensor is located axially between a pair of fan drive bearings.
